(19) United States
(12) Patent Application Publication
(10) Pub. No.: US 2025/0308738 A1
(43) Pub. Date: Oct. 2, 2025

(54) MAGNETIC BASE BODY AND COIL COMPONENT INCLUDING THE SAME

(71) Applicant: TAIYO YUDEN CO., LTD., Tokyo (JP)

(72) Inventors: Yoshihiro FUKUSHIMA, Tokyo (JP); Hirotaro SEINO, Tokyo (JP); Yasuyuki TAKI, Tokyo (JP); Masahiro HACHIYA, Tokyo (JP)

(21) Appl. No.: 19/077,923

(22) Filed: Mar. 12, 2025

(30) Foreign Application Priority Data
Mar. 29, 2024 (JP) 2024-056473

(51) Int. Cl. H01F 5/06; H01F 1/147; H01F 37/00

(52) U.S. Cl. CPC H01F 5/06; H01F 1/14791; H01F 37/005

(57) ABSTRACT

Provided is a magnetic base body having improved insulating properties of metal magnetic particles. A magnetic base body according to one embodiment includes: a plurality of metal magnetic particles containing Fe, Si, and an element a; first oxide films covering surfaces of the plurality of metal magnetic particles; and second oxide films covering surfaces of the first oxide films. The first oxide films are composed mainly of an oxide of Si. The second oxide films are composed mainly of an oxide of the element a. A first thickness indicating a thickness of the first oxide films is larger than a second thickness indicating a thickness of the second oxide films.

### CROSS-REFERENCE TO RELATED APPLICATIONS

This application is based on and claims the benefit of priority from Japanese Patent Application Serial No. 2024-056473 (filed on Mar. 29, 2024), the contents of which are hereby incorporated by reference in their entirety.

### TECHNICAL FIELD

The present disclosure relates mainly to a magnetic base body and a coil component including the magnetic base body.

### BACKGROUND

Soft magnetic base bodies containing a plurality of metal magnetic particles bonded together are used as magnetic base bodies for coil components. In the soft magnetic base body, the surfaces of the metal magnetic particles are covered with insulating films, and adjacent metal magnetic particles are bonded to each other via the insulating films. Since the soft magnetic base body is less prone to magnetic saturation than a magnetic base body made of ferrite, the soft magnetic base body is suitable as a magnetic base body for coil components used in large-current circuits.

The metal magnetic particles are made from an Fe-based raw powder, which is mainly composed of Fe. This Fe-based raw powder contains additive elements such as Si, Cr, and Al in addition to Fe to improve magnetic and insulation properties.

The insulating films on the surfaces of the metal magnetic particles may be formed of insulating coating films applied to the surfaces of the raw powder. The coating films covering the surfaces of the raw powder is formed, for example, by applying a liquid mixture of TEOS (tetraethoxysilane) and ethanol to the surfaces of the raw powder. Due to limitations in the manufacturing process, it is difficult to form thin, uniform coating films on the surfaces of the raw powder. Therefore, the coating films on the surfaces of the metal magnetic particles can degrade the magnetic properties (e.g., magnetic permeability) of the magnetic base body.

To obtain a magnetic base body with excellent magnetic properties, it is preferable to cover the surfaces of the metal magnetic particles with insulating oxide films formed by oxidizing the elements contained in the raw powder, rather than with coating films difficult to make thin. In Japanese Patent Application Publication No. 2014-143301 (“the '301 Publication”), a magnetic base body is disclosed that contains metal magnetic particles with oxide films containing Si oxide and Cr oxide formed on the surfaces. The metal magnetic particles are produced by heating a soft magnetic alloy powder containing Fe, Si, and Cr at 750° C.

As disclosed in the '301 Publication, the metal magnetic particles produced by heating a raw powder containing Fe, Si, and Cr each has a first oxide film mainly composed of silica (SiO₂) formed on the surface of the metal magnetic particle and a second oxide film mainly composed of chromium (III) oxide (Cr₂O₃) formed on the outer surface of the first oxide film.

The raw powder may contain Al added thereto. The metal magnetic particles produced by heating a raw powder containing Fe, Si, and Al each has a first oxide film mainly composed of silica (SiO₂) formed on the surface of the metal magnetic particle and a second oxide film mainly composed of alumina (Al₂O₃) formed on the outer surface of the first oxide film.

The oxide films formed on the surfaces of the metal magnetic particles are thinner than the coating films and may fail to provide sufficient insulation to the magnetic base body. In the soft magnetic base body in which the oxide films provide insulation between the metal magnetic particles, further improvement of the insulation between the metal magnetic particles is desired.

### SUMMARY

It is an object of the present disclosure to solve or alleviate at least part of the drawbacks mentioned above. More specifically, one object of the invention disclosed herein is to provide a magnetic base body having improved insulation properties.

Other objects of the disclosure will be made apparent through the entire description in the specification. The inventions recited in the claims may also address any other drawbacks in addition to the above drawback. The various inventions disclosed herein may be collectively referred to as “the invention”.

A magnetic base body according to one embodiment comprises: a plurality of metal magnetic particles containing Fe, Si, and an element a; first oxide films covering surfaces of the plurality of metal magnetic particles; and second oxide films covering surfaces of the first oxide films. The first oxide films are composed mainly of an oxide of Si. The second oxide films are composed mainly of an oxide of the element a. A first thickness indicating a thickness of the first oxide films is larger than a second thickness indicating a thickness of the second oxide films.

### ADVANTAGEOUS EFFECTS

According to the embodiments disclosed herein, it is possible to obtain a magnetic base body having improved insulating properties.

### BRIEF DESCRIPTION OF THE DRAWINGS

FIG. 1 is a schematic perspective view showing a coil component including a magnetic base body according to one embodiment.

FIG. 2 is an exploded perspective view of the coil component shown in FIG. 1.

FIG. 3 is a sectional view schematically showing a section of the coil component of FIG. 1 along the line I-I.

FIG. 4 is an enlarged sectional view schematically showing, on an enlarged scale, a part of a section of the magnetic base body according to one embodiment.

FIG. 5 shows line profiles obtained by EDS analysis along a scanning line SL1.

FIG. 6 is a flow chart showing a process of manufacturing a coil component according to one embodiment of the present disclosure.

FIG. 7 is a flow chart showing a process of manufacturing a coil component according to another embodiment of the present disclosure.

### DESCRIPTION OF THE PREFERRED EMBODIMENTS

Various embodiments of the disclosure will be described hereinafter with reference to the appended drawings. Throughout the drawings, the same components are denoted by the same reference numerals. For convenience of explanation, the drawings are not necessarily drawn to scale. The following embodiments of the present disclosure do not limit the scope of the claims. The elements included in the following embodiments are not necessarily essential to solve the problem addressed by the disclosure.

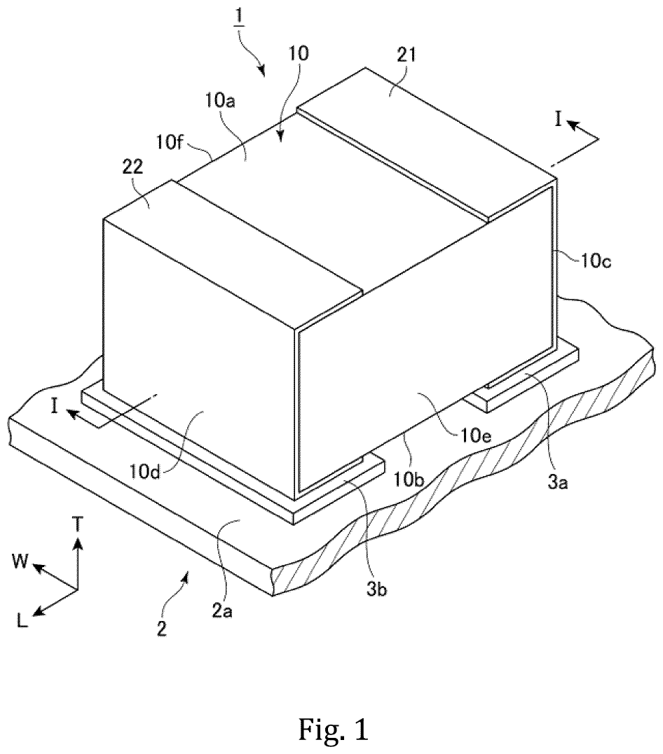

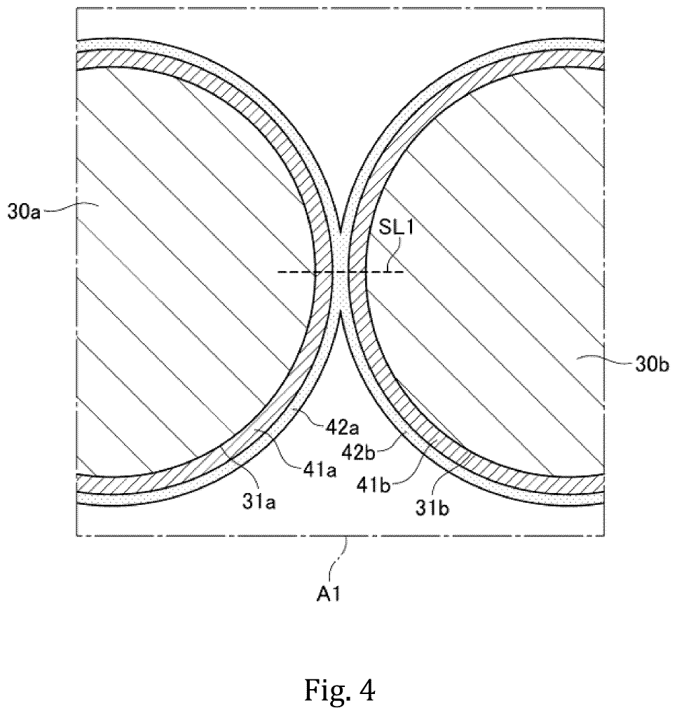

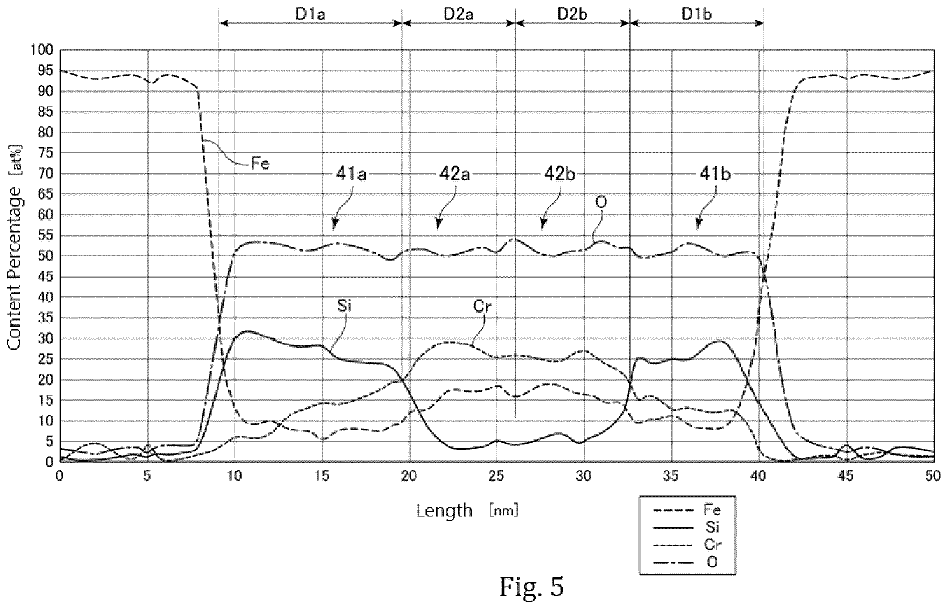

Some of the embodiments disclosed herein relates to a magnetic base body of a coil component. The magnetic base body contains a plurality of metal magnetic particles. The following first describes a coil component 1 including a magnetic base body 10 relating to one embodiment with reference to FIGS. 1 to 3, and then describes the microstructure of the magnetic base body with reference to FIGS. 4 and 5.

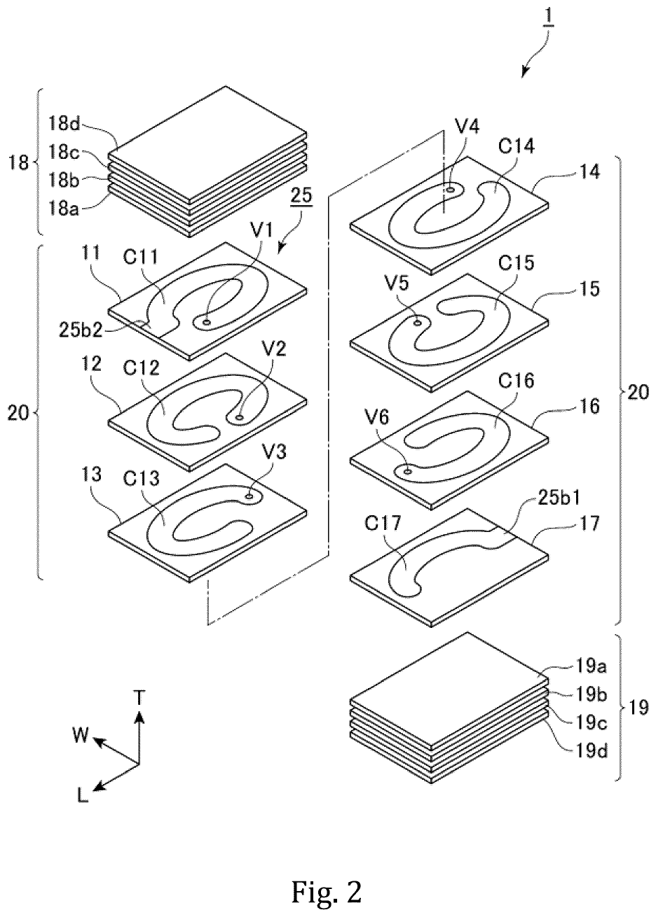

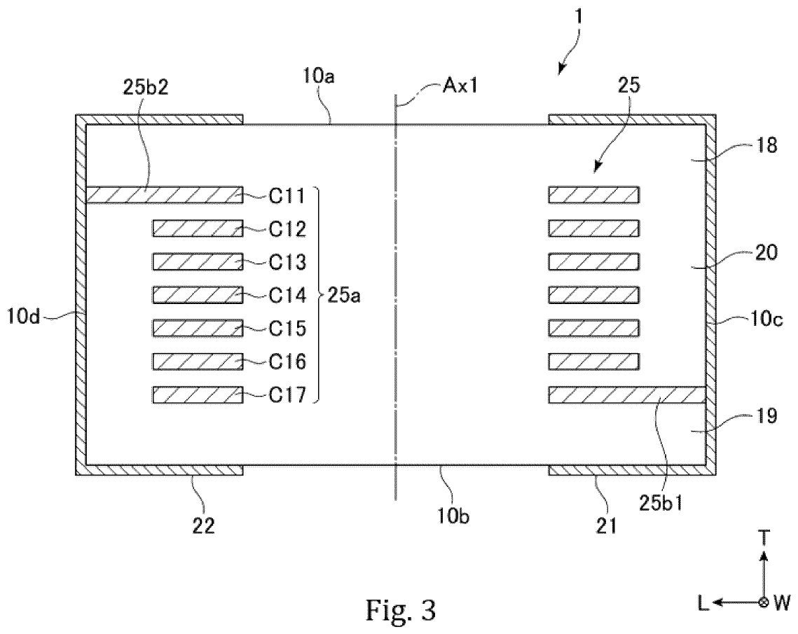

FIG. 1 is a schematic perspective view of the coil component 1, and FIG. 2 is an exploded perspective view of the coil component 1. FIG. 3 is a schematic sectional view of the coil component 1 along the line I-I of FIG. 1. In FIG. 2, external electrodes are not shown for convenience of description.

By way of one example of the coil component 1, FIGS. 1 to 3 show a laminated inductor. The laminated inductor shown is an example of the coil component 1 to which the invention can be applied. The invention can also be applied to various coil components other than the laminated inductor. For example, the coil component 1 may be applied to wire-wound coil components or planar coils.

As shown, the coil component 1 includes a base body 10, a coil conductor 25 provided in the base body 10, a first external electrode 21 disposed on a surface of the base body 10, and a second external electrode 22 disposed on the surface of the base body 10 at a position spaced apart from the first external electrode 21. The base body 10 is a magnetic base body made of a magnetic material. The base body 10 is an example of the “magnetic base body” recited in the claims. If the base body has low insulation properties, the external electrodes are attached to the surface of the base body via an insulating film having excellent insulation properties. As described below, the metal magnetic particles contained in the base body 10 to which the invention is applied have improved insulation properties, making it possible to attach the first and second external electrodes 21 and 22 directly to the base body 10 without an insulating film. In other words, the first and second external electrodes 21 and 22 may be attached directly to the surface of the base body 10.

The base body 10 contains a plurality of metal magnetic particles. The average particle size of the plurality of metal magnetic particles contained in the base body 10 is, for example, 1 to 20 μm. The average particle size of the metal magnetic particles contained in the base body 10 may be 1 to 10 μm or may be 2 to 8 μm. The average particle size of the metal magnetic particles contained in the base body 10 can be determined, for example, as follows. First, the base body 10 is cut or ground along its thickness direction (the T-axis direction) to expose a sectional surface. The sectional surface is photographed using a scanning electron microscope (SEM) to obtain an SEM image at a magnification of about 10,000 to 50,000. Next, the equivalent circle diameter (Haywood diameter) of each metal magnetic particle is determined in the SEM image by image analysis. The average value of the equivalent circle diameters of the metal magnetic particles in the SEM image can then be taken as the average particle size of the metal magnetic particles.

The first external electrode 21 is electrically connected to one end of the coil conductor 25, and the second external electrode 22 is electrically connected to the other end of the coil conductor 25.

The coil component 1 may be mounted on a mounting substrate 2a. In the illustrated embodiment, the mounting substrate 2a has lands 3a and 3b provided thereon. The coil component 1 is mounted on the mounting substrate 2a by bonding the first external electrode 21 to the land 3a and bonding the second external electrode 22 to the land 3b. A circuit board 2 according to one embodiment of the present disclosure includes the coil component 1 and the mounting substrate 2a having the coil component 1 mounted thereon. The circuit board 2 can be installed in various electronic devices. The electronic devices in which the circuit board 2 can be installed include smartphones, tablets, game consoles, electrical components of automobiles, servers, and various other electronic devices. The coil component 1 may be built in to a substrate.

The coil component 1 may be an inductor, a transformer, a filter, a reactor, an inductor array and any one of various other coil components. The coil component 1 may alternatively be a coupled inductor, a choke coil, and any one of various other magnetically coupled coil components. Applications of the coil component 1 are not limited to those explicitly described herein.

In the case where the coil component 1 is an inductor array or a magnetically coupled coil component, the coil conductor 25 is constituted by two or more conductor sections that are electrically insulated from each other in the base body 10.

In one embodiment of the present disclosure, the base body 10 is configured such that the dimension in the L-axis direction (length dimension) is greater than the dimension in the W-axis direction (width dimension) and the dimension in the T-axis direction (height dimension). For example, the coil component 1 has a length dimension of 1.0 mm to 6.0 mm, a width dimension of 0.5 mm to 4.5 mm, and a height dimension of 0.5 mm to 4.5 mm. The dimensions of the base body 10 are not limited to those specified herein. The term “rectangular parallelepiped” or “rectangular parallelepiped shape” used herein is not intended to mean solely “rectangular parallelepiped” in a mathematically strict sense. The dimensions and the shape of the base body 10 are not limited to those specified herein.

The base body 10 has a first principal surface 10a, a second principal surface 10b, a first end surface 10c, a second end surface 10d, a first side surface 10e, and a second side surface 10f. The outer surface of the base body 10 is defined by these six surfaces. The first principal surface 10a and the second principal surface 10b are at the opposite ends in the height direction of the base body 10, the first end surface 10c and the second end surface 10d are at the opposite ends in the length direction of the base body 10, and the first side surface 10e and the second side surface 10f are at the opposite ends in the width direction of the base body 10. As shown in FIG. 1, the first principal surface 10a, which is at the top of the base body 10, may be herein referred to as a “top surface.” Likewise, the second principal surface 10b may be herein referred to as a “lower surface” or “bottom surface.” Since the coil component 1 is disposed such that the second principal surface 10b faces the mounting substrate 2a, the second principal surface 10b may be herein referred to as “the mounting surface.” The top surface 10a and the bottom surface 10b are separated from each other by a distance equal to the height of the base body 10, the first end surface 10c and the second end surface 10d are separated from each other by a distance equal to the length of the base body 10, and the first side surface 10e and the second side surface 10f are separated from each other by a distance equal to the width of the base body 10.

As shown in FIG. 2, the base body 10 includes a body layer 20, a bottom cover layer 19 provided on the bottom-side surface of the body layer 20, and a top cover layer 18 provided on the top-side surface of the body layer 20. The top cover layer 18, bottom cover layer 19, and body layer 20 are the components of the base body 10.

The body layer 20 includes magnetic films 11 to 17. In the body layer 20, the magnetic films 17, 16, 15, 14, 13, 12 and 11 are stacked in the stated order from the negative side toward the positive side in the T-axis direction.

The magnetic films 11 to 17 have the conductor patterns C11 to C17, respectively, formed on the top-side surfaces thereof. The conductor patterns C11 to C17 each extend around a coil axis Ax1 (see FIG. 3) within a plane orthogonal to the coil axis Ax1 (the LW plane). The conductor patterns C11 to C17 are formed by, for example, printing a conductive paste made of a highly conductive metal or alloy via screen printing. The conductive paste is produced by mixing and kneading conductive powder made of conductive materials having excellent conductivity, such as Ag, Pd, Cu, Al or alloys of these, with a binder resin and a solvent. The binder resin may be PVB resins, phenolic resins, other resins known as binder resins, or mixtures thereof. When Cu powder is used as the conductive powder, a thermally decomposable resin such as acrylic resin may be used as the binder resin to prevent excessive oxidation of the Cu powder during degreasing. The conductive paste may contain modifiers for adjusting thixotropy. The conductor patterns C11 to C17 may be formed using other methods and materials. For example, the conductor patterns C11 to C17 may be formed by sputtering, ink-jetting, or other known methods.

The magnetic films 11 to 16 have vias V1 to V6, respectively, at a predetermined position therein. The vias V1 to V6 are formed by forming through holes at the predetermined positions in the magnetic films 11 to 16 so as to extend through the magnetic films 11 to 16 in the T-axis direction and filling the through holes with a conductive material. Each of the conductor patterns C11 to C17 is electrically connected to the respective adjacent conductor patterns through the vias V1 to V6.

The end of the conductor pattern C11 opposite to the end thereof connected to the via V1 is connected to the second external electrode 22. The end of the conductor pattern C17 opposite to the end thereof connected to the via V6 is connected to the first external electrode 21.

The top cover layer 18 includes magnetic films 18a to 18d made of a magnetic material, and the bottom cover layer 19 includes magnetic films 19a to 19d made of a magnetic material. In this specification of the present disclosure, the magnetic films 18a to 18d and the magnetic films 19a to 19d may be referred to collectively as “the cover layer magnetic films.” The components of the base body 10 do not necessarily have a lamination structure with a plurality of magnetic films stacked together. For example, the top cover layer 18 may be a compact formed of a magnetic material, rather than a laminate including a plurality of magnetic films 18a to 18d stacked together.

As shown in FIG. 3, the coil conductor 25 includes a winding portion 25a wound around the coil axis Ax1 extending along the thickness direction (T-axis direction), a lead-out portion 25b1 that extends from one end of the winding portion 25a to the first end surface 10c of the base body 10, and a lead-out portion 25b2 that extends from the other end of the winding portion 25a to the second end surface 10d of the base body 10. The conductor patterns C11 to C17 and the vias V1 to V6 form the winding portion 25a having a spiral shape. In other words, the winding portion 25a is constituted by the conductor patterns C11 to C17 and the vias V1 to V6.

The following now describes the microstructure of the base body 10 with reference to FIGS. 4 and 5. FIG. 4 is an enlarged sectional view schematically showing, on an enlarged scale, a partial region (region A1) of the section shown in FIG. 3. FIG. 4 schematically shows respective portions of two of the many metal magnetic particles contained in the base body 10. FIG. 5 shows line profiles obtained by EDS analysis along the scanning line SL1 shown in FIG. 4.

As shown in FIG. 4, the plurality of metal magnetic particles constituting the base body 10 include a first metal magnetic particle 30a and a second metal magnetic particle 30b. The first metal magnetic particle 30a and the second metal magnetic particle 30b are positioned adjacent to each other. In FIG. 4, the sections of the first metal magnetic particle 30a and the second metal magnetic particle 30b are drawn to be circular for convenience. The metal magnetic particles contained in the base body 10 may take various sectional shapes other than the circular shape. The metal magnetic particles contained in the base body 10 are mainly composed of Fe. The first metal magnetic particle 30a and the second metal magnetic particle 30b are examples of the metal magnetic particles contained in the base body 10. The description regarding the first metal magnetic particle 30a and the second metal magnetic particle 30b also applies to metal magnetic particles other than the first metal magnetic particle 30a or the second metal magnetic particle 30b contained in the base body 10.

The metal magnetic particles contained in the base body 10 should preferably contain Fe at a content percentage of 94 wt % or more so that the base body 10 has high magnetic saturation characteristics. The content percentage of Fe in the metal magnetic particles contained in the base body 10 is measured by cutting the base body 10 along the coil axis Ax to expose a section of the base body 10 and performing energy dispersive X-ray spectroscopy (EDS) analysis on this section. The content percentage of Fe can be measured by scanning electron microscopy (SEM) equipped with an energy dispersive X-ray spectroscopy (EDS) detector. The EDS analysis by SEM equipped with the EDS detector is called SEM-EDS analysis. The content percentage of Fe is measured, for example, using a scanning electron microscope SU7000 from Hitachi High-Tech Corporation and an energy dispersive X-ray spectroscopy detector Octane Elite from Ametek, Inc. at an acceleration voltage of 5 kV. The content percentages of elements other than Fe contained in the first metal magnetic particle 30a are also measured by SEM-EDS analysis, as is the content percentage of Fe.

In one aspect of the disclosure, crystalline regions occupy a larger area than amorphous regions in the metal magnetic particles contained in the base body 10. Since the crystalline regions have a larger area in the metal magnetic particles, the base body 10 can have an improved magnetic permeability. In one aspect of the disclosure, the metal magnetic particles contained in the base body 10 have a small number of, specifically, three or less crystals. At least some of the metal magnetic particles contained in the base body 10 should preferably be single crystals with a single crystal structure. When an electron beam diffraction pattern is measured for a sample containing metal magnetic particles taken from the base body 10, and this diffraction pattern is a net pattern (lattice spots) with a two-dimensional point array, the metal magnetic particles contained in the sample can be determined to be single crystals. The magnetic permeability of the base body 10 can be further improved when the metal magnetic particles are constituted by a smaller number of crystals.

The surface of each of the metal magnetic particles contained in the base body 10 is covered by a plurality of layers of oxide films having excellent insulation properties. Thus, the metal magnetic particles contained in the base body 10 are electrically insulated from each other. For example, at least between the first metal magnetic particle 30a and the second metal magnetic particle 30b, the surface 31a of the first metal magnetic particle 30a is covered by a first inner oxide film 41a, and the surface of the first inner oxide film 41a is covered by a first outer oxide film 42a. The surface 31b of the second metal magnetic particle 30b is covered by a second inner oxide film 41b, and the surface of the second inner oxide film 41b is covered by a second outer oxide film 42b. The first inner oxide film 41a should preferably cover the entire surface of the first metal magnetic particle 30a, and the second inner oxide film 41b should preferably cover the entire surface of the second metal magnetic particle 30b. The first inner oxide film 41a is in direct contact with the outer surface of the first metal magnetic particle 30a. The second inner oxide film 41b is in direct contact with the outer surface of the second metal magnetic particle 30b.

In the base body 10, each metal magnetic particle is bonded to adjacent metal magnetic particles via the oxide films on their respective surfaces. In other words, the oxide films on the surfaces of each of the adjacent metal magnetic metal particles are bonded to each other, and this bonding between the oxide films forms bonding between the metal magnetic particles covered by the oxide films. For example, the first metal magnetic particle 30a is bonded to the second metal magnetic particle 30b adjacent to the first metal magnetic particle 30a via at least one of the first outer oxide film 42a and the second outer oxide film 42b.

The metal magnetic particles contained in the base body 10 are produced, for example, by heating a raw powder made of soft magnetic material. As will be described later, the base body 10 may be fabricated by mixing soft magnetic metal powder made of a soft magnetic material with a resin to produce a mixed resin composition, and then heating the mixed resin composition. The heat treatment in the manufacturing process of the base body 10 causes the additive elements contained in the raw powder to diffuse to the surface of the raw powder and oxidize in the surface of the raw powder, and as a result, insulating films that contain oxides of the elements contained in the raw powder are formed on the surfaces of the metal magnetic particles. For example, the first inner oxide film 41a, the first outer oxide film 42a, the second inner oxide film 41b, and the second outer oxide film 42b described above are all oxide films containing oxides of additive elements in the raw powder.

The raw powder for the metal magnetic particles contained in the base body 10 are mainly composed of Fe. The raw powder for the metal magnetic particles contained in the base body 10 contains two or more additive elements in addition to Fe. For example, the raw powder for the metal magnetic particles contained in the base body 10 contains Si and at least one element a as additive elements in addition to Fe. As described above, the content percentage of Fe in the raw powder may be 94 wt % or more. The content percentage of Si in the raw powder may be 3 wt % or more. The content percentage of the element a in the raw powder may be less than 3 wt %. The content percentage of the element a in the raw powder may be 1 wt % or more.

In one embodiment, the element a is, for example, an element with a slower diffusion rate in Fe than Si. In addition, the element a is more apt to oxidation than Fe (i.e., the standard reaction Gibbs energy of the oxide is lower than that of Fe). For example, the element a is Cr or Al.

Both Si and the element a are more apt to oxidation than Fe. Thus, the presence of Si and the element a in addition to Fe in the raw powder inhibits the oxidation of Fe in the raw powder during the heat treatment. The raw powder for the metal magnetic particles may contain trace amounts of elements other than Fe, Si, and the element a. The elements that can be present in trace amounts in the raw powder for the metal magnetic particles can include vanadium (V), zinc (Zn), boron (B), carbon (C), and nickel (Ni).

The oxide films provided on the surfaces of the metal magnetic particles contained in the base body 10 contain oxides of the elements contained in the raw powder. The “oxide films provided on the surfaces of the metal magnetic particles contained in the base body 10” include the first inner oxide film 41a and the first outer oxide film 42a provided on the surface of the first metal magnetic particle 30a and the second inner oxide film 41b and the second outer side oxide film 42b provided on the surface of the second metal magnetic particle 30b. For convenience of description, the oxide films provided on the surfaces of the metal magnetic particles contained in the base body 10 may be referred to simply as the “oxide films”. Since Si and the element a are more apt to oxidation than Fe, when the raw powder contains Si and the element a in addition to Fe, the oxide films contain oxides of Si and oxides of the element A. In addition to the above oxides, the insulating film may contain oxide of at least one of vanadium (V), zinc (Zn), boron (B), carbon (C), and nickel (Ni).

The first inner oxide film 41a and the second inner oxide film 41b contain silica (SiO₂), an oxide of Si, as the main component. In the case where the EDS analysis shows that the amount of Si element (atomic percentage (at %) of Si element) is the largest among those of the elements other than oxygen contained in the first inner oxide film 41a, it can be determined that the first inner oxide film 41a contains silica as the main component. Since the first inner oxide film 41a is composed mainly of silica, which has a high volume resistivity, the first inner oxide film 41a has high insulating properties. The description regarding the first inner oxide film 41a also applies to the second inner oxide film 41b. The oxide films covering the surfaces of metal magnetic particles and containing silica as a main component may be herein referred to as “Si oxide films.” The Si oxide films are also provided on the surfaces of the metal magnetic particles contained in the base body 10 other than the first metal magnetic particle 30a and the second metal magnetic particle 30b.

The silica contained in the first and second inner oxide films 41a and 41b is formed when Si in the raw powder is oxidized during the heat treatment. Since Si diffuses at a high rate in Fe and a standard reaction Gibbs energy of Si oxides is low, Si diffuses to the surface of the raw powder during heat treatment of the raw powder composed mainly of Fe. Then, Si bonds with oxygen in the surface of the raw powder to form silica.

The first outer oxide film 42a and the second outer oxide film 42b contain oxides of the element a as the main component. When the element a is Cr, the main component of the first and second outer oxide films 42a and 42b is chromium (III) oxide (Cr₂O₃). When the element a is Al, the main component of the first and second outer oxide films 42a and 42b is alumina (Al₂O₃). In the case where the EDS analysis shows that the amount of the element a (at %) is the largest among those of the elements other than oxygen contained in the first outer oxide film 42a, it can be determined that the first outer oxide film 42a contains the oxide of the element a as the main component. The description regarding the first outer oxide film 42a also applies to the second outer oxide film 42b. The oxide films formed on the outer surfaces of the Si oxide films on the surfaces of the metal magnetic particles and containing chromium (III) oxide as the main component are herein referred to as the “Cr oxide films.” The oxide film formed on the outer surfaces of the Si oxide films on the surfaces of the metal magnetic particles and containing alumina as the main component may be herein referred to as the “Al oxide films.” The Cr oxide films or the Al oxide films are also provided on the surfaces of the metal magnetic particles contained in the base body 10 other than the first metal magnetic particle 30a and the second metal magnetic particle 30b.

The oxide of the element a contained in the first and second outer oxide films 42a and 42b is formed when the element a in the raw powder is oxidized during the heat treatment. Since the element a diffuses within Fe at a lower rate than Si, the element a is oxidized after Si is oxidized in the surface of the raw powder. Therefore, the first outer oxide film 42a and the second outer oxide film 42b are formed on the outer side of the first inner oxide film 41a and the second inner oxide film 41b, respectively, which are mainly composed of silica.

As shown in FIG. 4, the first inner oxide film 41a has a larger thickness than the first outer oxide film 42a. The second inner oxide film 41b has a larger thickness than the second outer oxide film 42b. More generally, in the metal magnetic particles contained in the base body 10, the Si oxide films have a larger thickness than the oxide films mainly composed of the oxide of the element a (Cr oxide films or Al oxide films). Silica has a higher volume resistivity than chromium (III) oxide or alumina. Therefore, since the first and second inner oxide films 41a and 41b composed mainly of silica have a larger thickness than the first and second outer oxide films 42a and 42b composed mainly of chromium (III) oxide or alumina, the insulating properties of the first metal magnetic particle 30a and the second metal magnetic particle 30b can be improved.

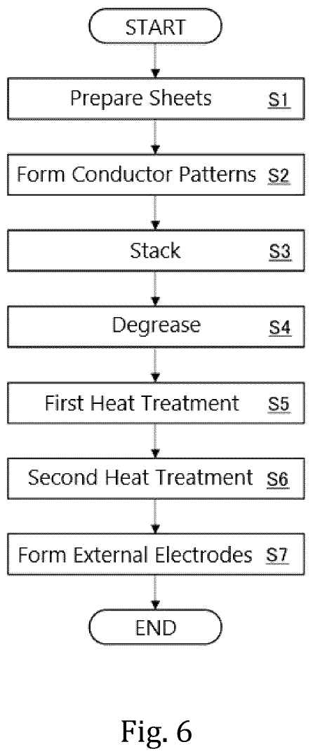

In conventional magnetic base bodies, the Si oxide film has a smaller thickness than the Cr oxide film in the surfaces of the metal magnetic particles. For example, the '301 Publication discloses the results of EDS analysis of the surfaces of metal magnetic particles produced by heating Fe—Si—Cr-based raw powder (see FIG. 6(b)). These results show that the Cr oxide film has a larger thickness than the Si oxide film on the surfaces of the metal magnetic particles. As described above, when the raw powder is heated, Fe, Si, and Cr or Al contained in the raw powder diffuse toward the surface of the raw powder. Among the major elements contained in the raw powder, Si diffuses at the highest rate, and therefore, silica is formed on the surface of the raw powder, but as the heat treatment proceeds, chromium (III) oxide or alumina are also formed. When the amount of chromium (III) oxide or alumina produced increases, a passive film of chromium (III) oxide or alumina is formed on the surface of the raw powder. Once this passive film is formed, Si on the surface of the raw powder cannot bond with oxygen, and thus the passive film inhibits the growth of the Si oxide film. On the other hand, a passive film of chromium (III) oxide or alumina will grow as long as outward diffusion of Cr or Al from inside the raw powder continues. Since the passive film of chromium (III) oxide or alumina inhibits the growth of the Si oxide film, the Cr oxide film or Al oxide film has a larger thickness than the Si oxide film on the surfaces of conventional metal magnetic particles.

By contrast, in an aspect of the present disclosure, as described above, the first inner oxide film 41a, which is mainly composed of silica, has a larger thickness than the first outer oxide film 42a, which is mainly composed of chromium (III) oxide or alumina, and the second inner oxide film 41b, which is mainly composed of silica, has a larger thickness than the second outer oxide film 42b, which is mainly composed of chromium (III) oxide or alumina. The Inventor noted that the diffusion rate of Si in Fe is higher than that of the element a (Cr or Al) and that the diffusion rate strongly depends on temperature according to the Arrhenius equation, and found that heating at a lower temperature than in conventional methods to the extent that thermal diffusion of Si is active but that of Cr or Al is not active makes it possible to form the Si oxide film having a large thickness before Cr or Al form a passive film on the surface of the raw powder. Using this principle, in an aspect of the present disclosure, a first-stage heat treatment is first performed in which the raw powder is heated at a relatively low temperature (500 to 700° C., as described below) to form thick Si oxide films on the surface of the raw powder, and after the Si oxide films are formed on the surface of the raw powder, a second-stage heat treatment is performed in which the raw powder is heated at a relatively high temperature (750 to 900°° C., as described below) to make the Si oxide films (for example, the first inner oxide film 41a and the second inner oxide film 41b) formed on the surfaces of the metal magnetic particles thicker than the Cr oxide films or the Al oxide films (for example, the first outer oxide film 42a and the second outer oxide film 42b). Thus, in the present disclosure, the insulating properties of the metal magnetic particles contained in the base body 10 can be improved.

The first inner oxide film 41a, the first outer oxide film 42a, the second inner oxide film 41b, and the second outer oxide film 42b are interposed between the first metal magnetic particle 30a and the second metal magnetic particle 30b adjacent to each other in the base body 10. Since the first and second inner oxide films 41a and 41b composed mainly of silica having a high volume resistivity have a larger thickness than the first and second outer oxide films 42a and 42b, it is possible to reduce the overall thickness of the oxide films provided on the surfaces of the metal magnetic particles to ensure the insulation required for the base body 10. By reducing the total thickness of the oxide films interposed between adjacent metal magnetic particles, the filling factor of the metal magnetic particles in the base body 10 can be improved, thus improving the magnetic permeability of the base body 10. Therefore, with the Si oxide films provided on the surfaces of the metal magnetic particles and having a larger thickness than the Cr oxide films or Al oxide films, the magnetic permeability of the base body 10 can be improved while ensuring the insulation properties.

Since Si is less likely to diffuse into grain boundaries than Cr or Al when the raw powder is heated, the thickness of the Si oxide films (e.g., first and second inner oxide films 41a and 41b) can be precisely controlled by the content percentage of Si in the raw powder, the temperature in the heat treatment, and the duration of heating.

The presence of each oxide film and its thickness can be confirmed as follows. Specifically, an analysis sample is prepared by slicing the base body 10 so that a surface parallel to the plane extending along the coil axis (e.g., LT plane) is an observation surface, and an observation region spanning two metal magnetic particles is set in the observation surface of the sliced analysis sample. Then, mapping data for Fe, Si, the element a, and O (oxygen) can be obtained by SEM-EDS in this observation region, and the presence of each oxide film can be confirmed based on the mapping data.

FIG. 4 shows a sectional surface along the LT plane of the base body 10 containing two metal magnetic particles (the first metal magnetic particle 30a and the second metal magnetic particle 30b). The following further describes the detection of oxide films based on the mapping data, assuming that the region A1 shown in FIG. 4 represents the observation surface of the sliced analysis sample. The detection of each oxide film by SEM-EDS analysis in the observation region A1 shown in FIG. 4 can proceed, for example, as follows. First, SEM-EDS is performed on the observation region A1 to obtain mapping data of the quantitative elements contained in the observation region A1 of the analysis sample. The observation region A1 is, for example, a square region with sides of 200 nm. The quantitative elements include Fe, Si, the element a, and O. Next, a line analysis is performed based on the mapping data obtained. Specifically, a scanning line SL1 is set in the observation region A1 to extend from the first metal magnetic particle 30a to the second metal magnetic particle 30b, and a line profile is created for each of the quantitative elements by reconstructing the mapping data of the quantitative element along the scanning line SL1. The length of the scanning line SL1 is 50 nm, for example. The length of the scanning line SL1 for obtaining the line profiles can be changed appropriately.

FIG. 5 shows an example of line profiles reconstructed along scanning line SL1 from the mapping data obtained by SEM-EDS in the region A1 of the analysis sample. The line profiles in FIG. 5 are an example of a graph obtained as follows: an analysis sample is prepared from the base body 10 containing the metal magnetic particles produced by heating a Fe—Si—Cr-based raw powder, and the analysis sample is subjected to SEM-EDS to obtain mapping data of the elements Fe, Si, Cr, and O which is then reconstructed along the scanning line SL1. In FIG. 4, the horizontal axis represents the detection position on the scanning line SL1, and the vertical axis represents the detection intensity calculated based on the counts of Fe, Si, Cr, and O at each detection position.

Both ends of the graph in FIG. 5 in the horizontal axis direction correspond to both ends of the scanning line SL1 in FIG. 4, and thus the regions near both ends of the graph in FIG. 5 in the horizontal axis direction correspond to the first metal magnetic particle 30a and the second metal magnetic particle 30b, respectively. In the graph shown in FIG. 5, there are regions that contain about 94 at % or more Fe as the main component near both ends of the scanning line SL1, and therefore, it can be determined that, of these regions, the region near the left end of the graph corresponds to the first metal magnetic particle 30a, and the region near the right end of the graph corresponds to the second metal magnetic particle 30b.

In FIG. 5, the Si detection intensity increases and conversely the Fe detection intensity decreases toward the right along the horizontal axis from the region corresponding to the first metal magnetic particle 30a. Then, the Si line profile intersects the Fe line profile at about 9 nm from the starting point of the scanning line SL1. In the region with a width of about 20 nm to the right of the intersection of the Fe line profile and the Si line profile, the Si content is the highest among Fe, Si, and Cr contents. The region in which the Si content is the highest corresponds to the first inner oxide film 41a. Further toward the right along the horizontal axis from the region corresponding to the first inner oxide film 41a, the Si detection intensity decreases and conversely the Cr detection intensity increases, and the Si line profile intersects the Fe line profile. The intersection of the Si line profile and the Cr line profile is the boundary between the first inner oxide film 41a and the first outer oxide film 42a on the outer side thereof. Likewise, the boundary between the second metal magnetic particle 30b and the second inner oxide film 41b and the boundary between the second inner oxide film 41b and the second outer oxide film 42b can be determined by moving from the right end of the graph in FIG. 5 toward the left while focusing on the Fe, Si, and Cr contents.

The lengths along the horizontal axis of the first inner oxide film 41a, first outer oxide film 42a, second inner oxide film 41b, and second outer oxide film 42b identified as described above can be measured to determine the thicknesses of these oxide film. In the example shown in FIG. 5, the thicknesses of the first inner oxide film 41a, first outer oxide film 42a, second inner oxide film 41b, and second outer oxide film 42b are D1a, D2a, D1b, and D2b, respectively. The thickness D1a of the first inner oxide film 41a is larger than the thickness D2a of the first outer oxide film 42a. The thickness D1b of the second inner oxide film 41b is larger than the thickness D2b of the second outer oxide film 42b.

In one aspect of the present disclosure, the thickness D1a of the first inner oxide film 41a should preferably be two or more times as large as the thickness D2a of the first outer oxide film 42a. The thickness D1b of the second inner oxide film 41b should preferably be two or more times as large as the thickness D2b of the second outer oxide film 42b. When the thickness D1a of the first inner oxide film 41a is two or more times as large as the thickness D2a of the first outer oxide film 42a, and the thickness D1b of the second inner oxide film 41b is two or more time as large as the thickness D2b of the second outer oxide film 42b, the first and second inner oxide films 41a and 41b composed mainly of silica and having a high volume resistivity can improve the insulation properties of the first metal magnetic particle 30a and the second metal magnetic particle 30b.

In one aspect of the present disclosure, the thickness D1a of the first inner oxide film 41a should preferably be four or less times as large as the thickness D2a of the first outer oxide film 42a. The thickness D1b of the second inner oxide film 41b should preferably be four or less times as large as the thickness D2b of the second outer oxide film 42b. When the thickness D1a of the first inner oxide film 41a is four or less times as large as the thickness D2a of the first outer oxide film 42a, and the thickness D1b of the second inner oxide film 41b is four or less times as large as the thickness D2b of the second outer oxide film 42b, the filling factor of metal magnetic particles in the base body 10 can be inhibited from being reduced.

In an aspect of the present disclosure, the thickness D1a of the first inner oxide film 41a and the thickness D1b of the second inner oxide film 41b can both be from 10 nm to 50 nm. In an aspect of the present disclosure, the thickness D2a of the first outer oxide film 42a and thickness D2b of the second outer oxide film 42b can be 10 to 25 nm within the range that satisfies the condition that these thicknesses are smaller than the thickness D1a of the first inner oxide film 41a and the thickness D1b of the second inner oxide film 41b.

The insulation between the first and second metal magnetic particles 30a and 30b should preferably be ensured mainly by the first and second inner oxide films 41a and 41b. In other words, it is preferable that the first inner oxide film 41a and the second inner oxide film 41b electrically insulate the first metal magnetic particle 30a and the second metal magnetic particle 30b, regardless of the thicknesses of the first outer oxide film 42a and the second outer oxide film 42b. When the electrical insulation between the first metal magnetic particle 30a and the second metal magnetic particle 30b is ensured by the first inner oxide film 41a and the second inner oxide film 41b, the thicknesses of the first outer oxide film 42a and the second outer oxide film 42b can be reduced, resulting in an increased filling factor of metal magnetic particles in the base body 10. In addition, Cr and Al tend to diffuse into the grain boundaries during the heat treatment of the magnetic powder, and thus it is difficult to precisely control the thicknesses of the first and second outer oxide films 42a and 42b. Therefore, regardless of the thicknesses of the first outer oxide film 42a and the second outer oxide film 42b, the necessary resistance for insulation is provided by the first inner oxide film 41a and the second inner oxide film 41b, thereby further ensuring the insulation between the first metal magnetic particle 30a and the second metal magnetic particle 30b.

If there is a large irregularity in the thickness of the first inner oxide film 41a or the second inner oxide film 41b, dielectric breakdown may occur from the portion of the first inner oxide film 41a or the second inner oxide film 41b having a small thickness. Therefore, the thicknesses of the first inner oxide film 41a and the second inner oxide film 41b should be highly uniform. In one aspect of the disclosure, the standard deviation Cv1 of the thickness of the first inner oxide film 41a and the standard deviation Cv2 of the thickness of the second inner oxide film 41b should both be 3 nm or less. The standard deviation Cv1 of the thickness of the first inner oxide film 41a refers to the standard deviation calculated from the thicknesses of the first inner oxide film 41a measured at five different positions in the circumferential direction around the geometric center of the first metal magnetic particle 30a. The standard deviation Cv2 of the thickness of the second inner oxide film 41b refers to the standard deviation calculated from the thicknesses of the second inner oxide film 41b measured at five different positions in the circumferential direction around the geometric center of the second metal magnetic particle 30b.

The base body may be produced from a raw powder having a liquid mixture of TEOS (tetraethoxysilane) and ethanol applied to the surfaces of the raw powder, so as to provide coating films composed mainly of silica on the surfaces of the metal magnetic particles. In an aspect of the present disclosure, the Si oxide films (e.g., the first inner oxide film 41a and the second inner oxide film 41b) formed on the surfaces of the metal magnetic particles constituting the base body 10 are oxide films mainly composed of silica which are produced by Si contained in the raw powder being oxidized on the surfaces of the raw powder during heat treatment of the raw powder containing Fe and Si, rather than coating films produced by the application of coating liquids. As shown in the graph of FIG. 5, the first and second inner oxide films 41a and 41b are oxide films composed mainly of silica, but also containing Fe and Cr diffused during the heat treatment of the raw powder. On the other hand, the coating films of silica usually do not contain any constituent elements of the raw powder other than Si. Therefore, the first and second inner oxide films 41a and 41b can be distinguished from the coating film containing silica in that they contain elements derived from raw powder other than Si (Fe and Cr in the example in FIG. 5).

Next, one example of a manufacturing method of the coil component 1 will be described with reference to FIG. 6. Since the base body 10 is fabricated in the process of manufacturing the coil component 1, the manufacturing method of the base body 10 is also described with reference to FIG. 6. In the following, it is assumed that the coil component 1 is manufactured by the sheet lamination method. The coil component 1 may also be manufactured by any known methods other than the sheet lamination method. For example, the coil component 1 may be manufactured by a lamination method such as a printing lamination method, a thin-film process method, or a slurry build method.

In the first step S1, magnetic sheets are fabricated. The magnetic sheets are produced from a magnetic material paste obtained by mixing and kneading soft magnetic metal powder (raw powder), which is the raw material of the metal magnetic particles, with a binder resin and a solvent. The raw powder is formed of a soft magnetic metal material. The raw powder contains Fe, Si, and the element a. In the following description of the manufacturing method, it is assumed for clarity of description that the raw powder contains Cr as the element a. The raw powder may contain 94 wt % or more Fe. The raw powder contains more Si than Cr on a mass basis. For example, the raw powder contains 3 wt % or more Si.

The binder resin for the magnetic material paste is, for example, an acrylic resin. The binder resin for the magnetic material paste may be PVB resins, phenolic resins, other resins known as binder resins, or mixtures thereof. One example of the solvent is toluene. The magnetic material paste is applied to the surface of a plastic base film by the doctor blade method or other common methods. The magnetic material paste applied to the surface of the base film is dried to obtain sheet-shaped compacts. A molding pressure of approximately 10 MPa to 100 MPa is applied for molding to the sheet-shaped compacts in the mold, so that a plurality of magnetic sheets are obtained.

Next, in step S2, a conductive paste is applied to some of the plurality of magnetic sheets prepared in step S1. The conductive paste is produced by mixing and kneading conductive powder made of conductive materials having excellent conductivity, such as Ag, Pd, Cu, Al or alloys of these, with a binder resin and a solvent. The binder resin for the conductive paste may be the same as the binder resin for the magnetic material paste. Both the binder resin for the conductive paste and the binder resin for the magnetic material paste may be acrylic resins.

By applying the conductive paste to the magnetic sheets, unfired conductor patterns to be the conductor patterns C11 to C17 after firing are formed on the associated magnetic sheets. A plurality of unfired conductor patterns are formed on each magnetic sheet. For example, a plurality of unfired conductor patterns to be the conductor patterns C11 after firing are formed on a certain magnetic sheet. A through hole is formed in some of the magnetic sheets to penetrate the magnetic sheets in the stacking direction. When the conductive paste is applied to a magnetic sheet with a through hole, the conductive paste is also filled into the through hole. In this way, unfired via conductors are formed in the through holes of the magnetic sheets, and these unfired via conductors will be via conductors V1 to V6 after firing. The conductive paste is applied to the magnetic sheets by, for example, screen printing.

Next, in step S3, the magnetic sheets prepared in step S1 are stacked together to form a top laminate to be the top cover layer 18, an intermediate laminate to be the body layer 20, and a bottom laminate to be the bottom cover layer 19. The top laminate and the bottom laminate are each formed by stacking four magnetic sheets prepared in step S1 and having no unfired conductor pattern formed thereon. The four magnetic sheets of the top laminate will be the magnetic films 18a to 18d respectively in the finished coil component 1, and the four magnetic sheets of the bottom laminate will be the magnetic films 19a to 19d respectively in the finished coil component 1. The intermediate laminate is formed by stacking in a predetermined order seven magnetic sheets each having an unfired conductor pattern formed thereon. The seven magnetic sheets of the intermediate laminate will be the magnetic films 11 to 17 respectively in the finished coil component 1. The intermediate laminate formed in the above-described manner is sandwiched between the top laminate on the top side and the bottom laminate on the bottom side, and the top laminate and the bottom laminate are bonded to the intermediate laminate by thermal compression to obtain a body laminate. Next, the body laminate is diced by a cutter such as a dicing machine or a laser processing machine to obtain a chip laminate. The chip laminate is an example of a compact that includes an element body to be the base body 10 after the heat treatment and unfired conductor patterns to be the coil conductor 25 after the heat treatment. The compact that includes the element body to be the base body 10 after the heat treatment and the unfired conductor patterns to be the coil conductor 25 after the heat treatment may be fabricated by a method other than the sheet lamination method.

Next, in step S4, the compact fabricated in step S3 is degreased. The degreasing process for the compact may be performed in a non-oxygen atmosphere such as a nitrogen atmosphere. By performing the degreasing process in a non-oxygen atmosphere, the oxidation of Fe contained in the raw powder can be prevented during the degreasing process. The degreasing process is performed at a temperature of 300° C. to 500° C. for a duration of 30 to 60 minutes, for example. Since the degreasing process decomposes the thermally decomposable resin contained in the compact, no thermally decomposable resin remains in the compact after the degreasing process is completed. When the binder resin for the conductive paste is the same thermally decomposable resin as the binder resin for the magnetic material paste, the binder resin contained in the unfired conductor patterns is also thermally decomposed during the degreasing process in step S4. Thus, in step S4, both the magnetic sheets and the unfired conductor patters constituting the compact are degreased.

In the degreasing process in step S4, the raw powder is heated at a temperature of about 300 to 500° C., so the elements in the raw powder are thermally diffused toward the outer surface of each powder particle. The raw powder is mainly composed of Fe. The diffusion rate of Si in Fe is higher than that of Cr in Fe. Therefore, the degreasing process results in a higher concentration of Si, which diffuses at a higher rate in Fe, near the surface of each powder particle constituting the raw powder.

Next, in step S5, the degreased compact is subjected to first heat treatment. The first heat treatment is performed in a low oxygen concentration atmosphere containing oxygen in a range of 5 to 1000 ppm at a first heating temperature of 500° C. to 700° C. Heating the raw powder at 500 to 700° C. in an oxygen-containing atmosphere further promotes the thermal diffusion of Si near the surface of each raw powder particle, and the Si diffused near the surface bonds with oxygen in the atmosphere to form silica on the surface of each powder particle. Cr in the raw powder also diffuses near the surface of each powder particle, but since its diffusion rate in Fe is lower than that of Si, the concentration of Cr near the surface of each powder particle is lower than that of Si when the first heat treatment is performed. Therefore, oxidation of Si occurs more actively than oxidation of Cr during the first heat treatment. Therefore, the first heat treatment mainly produces oxide of Si among the additive elements contained in each raw powder particle, since the concentration of Si is high near the surface and Si is apt to oxidation. The first heat treatment forms Si oxide films, mainly composed of Si oxide, on the surfaces of the raw powder particles. The first heating time during which the first heat treatment is performed is a time sufficient for Si oxide films of a desired thickness to be formed on the surfaces of the raw powder particles. The first heating time may be, for example, one to six hours. As mentioned above, the thickness D1a of the Si oxide films (e.g., the first inner oxide film 41a or the second inner oxide film 41b) formed on the surfaces of the metal magnetic particles can be 10 to 50 nm. As the first heating time is longer, the thickness of the Si oxide films can be increased.

Next, in step S6, second heat treatment is performed on the compacts having been heated in the first heat treatment at a second heating temperature higher than the first heating temperature for a second heating time. The second heat treatment should preferably be performed in an atmosphere with a higher oxygen concentration than the atmosphere in which the first heat treatment was performed, in order to promote the formation of Cr oxide films. For example, the second heat treatment is performed in an atmosphere containing oxygen in the range of 500 to 10,000 ppm. The second heating temperature and the second heating time are set so that Cr oxide films are formed on the surfaces of the raw powder particles on which the Si oxide films have been formed in step S5. The second heating temperature may be, for example, 750°° C. to 900° C. During the second heat treatment, the diffusion rate of Cr is higher because the raw powder is heated at the second heating temperature, and a sufficient amount of Cr is diffused to form Cr oxide films on the surfaces of the raw powder particles. Therefore, the second heat treatment causes Cr to contact with oxygen on the surfaces of the raw powder particles having the Si oxide films formed thereon (the outer surfaces of the Si oxide films) to form chromium (III) oxide. The chromium (III) oxide produced in this way forms Cr oxide films.

In the second heat treatment in step S6, unoxidized Si present in the surfaces of the raw powder particles, if any, is oxidized to form SiO₂ on the surfaces of the raw powder particles, and thus the Si oxide films grow further. Also, in the second heat treatment, if magnetite is present near the Cr diffused to the surfaces of the raw powder particles, Cr and magnetite combine to form chromite (FeCr₂O₄).

Since the standard reaction Gibbs energy of Cr oxides is larger (smaller in absolute value) than that of Si oxides, the second heat treatment may be performed at a higher oxygen concentration than the first heat treatment to promote oxidation of Cr. For example, the second heat treatment may be performed in a low oxygen concentration atmosphere of 1,000 to 10,000 ppm.

During the second heat treatment, in addition to oxidation of the raw powder, sintering of the conductive powder in the unsintered conductor patterns also occurs. The coil conductor 25 is obtained by sintering the conductive powder in the unsintered conductor patterns. When copper powder is used as the conductive powder, the copper crystals sinter densely to form the coil conductor 25.

The second heat treatment causes adjacent metal magnetic particles to bond with each other via insulating films (specifically, the Cr oxide films) formed on their surfaces. In this way, the base body 10 containing metal magnetic particles bonded to each other is obtained.

Thus, by heating the raw powder at a relatively low first heating temperature in the first heat treatment and then continuously heating the raw powder at a relatively high second heating temperature in the second heat treatment, thick Si oxide films (the first inner oxide film 41a and the second inner oxide film 41b) can be formed on the surfaces of the raw powder particles, and then Cr oxide films (the first outer oxide film 42a and the second outer oxide film 42b) can be formed on the surfaces of the Si oxide films. The thickness of the Si oxide films can be increased by elongating the first heating time for applying the first heat treatment or by increasing the Si content in the raw powder.

As mentioned above, the thickness of the Si oxide films can be 10 to 50 nm. Since the Si oxide films have a thickness of 10 nm or larger, the base body 10 can achieve a high volume resistivity of 10⁵ ⋅· cm or higher. The volume resistivity of the base body 10 can be measured in conformity to JIS-K6911.

The second heat treatment forms thin Cr oxide films, which are passive films, on the surfaces of the Si oxide films, and these Cr oxide films inhibit excessive growth of the Si oxide films. The Cr oxide films can be made thinner by adjusting the parameters of the second heat treatment (e.g., the heating time). This prevents the oxide films on the surfaces of the metal magnetic particles from being excessively thick.

Next, in step S7, the first external electrode 21 and the second external electrode 22 are formed on the surface of the base body 10 obtained in step S6. The first external electrode 21 is connected to one end of the coil conductor 25, and the second external electrode 22 is connected to the other end of the coil conductor 25. The compact having gone through the second heat treatment may be impregnated with a resin before the first and second external electrodes 21 and 22 are formed. The compact is impregnated with, for example, a thermosetting resin such as an epoxy resin. This allows the resin to penetrate the gaps between the metal magnetic particles in the base body 10. The resin that has penetrated into the base body 10 may be set to increase the mechanical strength of the base body 10.

The coil component 1 is fabricated through the steps described above.

When the raw powder contains Al instead of Cr as the element a, the same mechanism is used to form Si oxide films thick enough to ensure insulation on the surfaces of the raw powder particles by the first heat treatment, and then to form Al oxide films composed mainly of alumina on the surfaces of the Si oxide films by the second heat treatment.

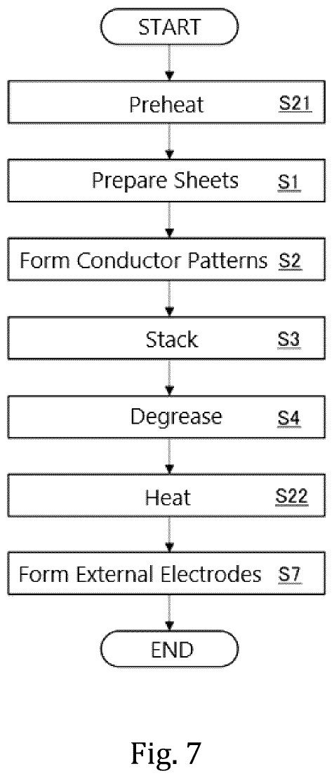

Next, another aspect of the manufacturing method of the coil component 1 will be described with reference to FIG. 7. The manufacturing method shown in FIG. 7 differs from that shown in FIG. 6 in that before the magnetic sheets are fabricated, the raw powder is preheated to produce Si oxide films on the surfaces of the raw powder particles.

As shown in FIG. 7, in the first step S21, the raw powder, which is the raw material for the metal magnetic particles, is prepared and then preheated. Preheating is performed at 300 to 700°° C. for 30 minutes to 1 hour. The preheating produces Si oxide films on the surfaces of the raw powder particles. Using this raw powder having the Si oxide films formed on the surface thereof, steps S1 to S3 are performed as in FIG. 6 to produce a compact including the magnetic sheets stacked together. In step S4, the compact is degreased.

Next, in step S22, the degreased compact is subjected to heat treatment. The heat treatment in step S22 can be performed under the same conditions as the second heat treatment performed in step S6 of FIG. 6. The second heat treatment further forms Cr oxide films on the surfaces of the raw powder particles covered by the Si oxide films in the compact, and thus the raw powder is formed into metal magnetic particles. The heat treatment in step S22 causes adjacent metal magnetic particles to bond with each other via the Cr oxide films formed on their surfaces. In this way, the base body 10 containing metal magnetic particles bonded to each other is obtained.

Next, in step S7, the first external electrode 21 and the second external electrode 22 are formed on the surface of the base body 10 obtained in step S22. The coil component 1 is fabricated through the steps described above.

In this way, after thick Si oxide films are formed on the surfaces of the raw powder particles by heating the raw powder at a relatively low temperature in the preheating in step S21, Cr oxide films are formed on the outer side of the Si oxide films by further heating the raw powder at a relatively high temperature in the heat treatment in step S22.

### EXAMPLES

A prototype of coil component 1 was made from a raw powder containing Fe, Si, and Cr in accordance with the flowchart shown in FIG. 6. The raw powder was composed of 95 wt % Fe, 4 wt % Si, and 1 wt % Cr. A compact containing the raw powder and a binder resin was prepared in accordance with the procedure in step S3. The compact was then degreased. In the degreasing process, the compact was heated at 350° C. for 60 minutes in a nitrogen atmosphere. Next, the first heat treatment was performed on the degreased compact. The first heat treatment was performed at a heating temperature of 600° C. for 2 hours in an atmosphere containing 500 ppm oxygen. Next, the second heat treatment was performed on the compact after the first heat treatment. The second heat treatment was performed in an atmosphere containing oxygen of 5,000 ppm. The EDS analysis was performed on the base body obtained by the second heat treatment. Specifically, an analysis sample is prepared by slicing the base body, and an observation region spanning two metal magnetic particles was set in the observation surface of the sliced analysis sample. The SEM-EDS was performed on the observation region to obtain the mapping data for Fe, Si, Cr, and O (oxygen). Next, a scanning line extending across the border between two adjacent metal magnetic particles was set in the observation region, and a line profile was created for each of the quantitative elements by reconstructing the mapping data for Fe, Si, Cr, and O along the scanning line. The line profiles thus created are shown in FIG. 5. As shown in FIG. 5, it was confirmed that Si oxide films having a thickness of about 15 nm to 20 nm were formed on the surfaces of the metal magnetic particles, and Cr oxide films having a thickness of about 10 nm, smaller than that of the Si oxide films, were formed on the outer surfaces of the Si oxide films.

It was confirmed that Si oxide films having a thickness of 10 to 50 nm were formed on the surfaces of the metal magnetic particles and Cr oxide films thinner than the Si oxide films were formed on the outer surfaces of the Si oxide films, even if the conditions were changed within the range of conditions shown in the description of the manufacturing process in FIG. 6. When Cr was replaced with Al, it was confirmed that Si oxide films having a thickness of 10 to 50 nm were formed on the surfaces of the metal magnetic particles, and Al oxide films thinner than the Si oxide films were formed on the outer surfaces of the Si oxide films.

The dimensions, materials, and arrangements of the constituent elements described for the above various embodiments are not limited to those explicitly described for the embodiments, and these constituent elements can be modified to have any dimensions, materials, and arrangements within the scope of the present disclosure.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

This specification also discloses the following embodiments.

### Additional Embodiment 1

A magnetic base body comprising:
a plurality of metal magnetic particles containing Fe, Si, and an element a;
first oxide films (41a) covering surfaces of the plurality of metal magnetic particles and composed mainly of an oxide of Si; and
second oxide films (42a) covering surfaces of the first oxide films and composed mainly of an oxide of the element a,
wherein a first thickness indicating a thickness of the first oxide films is larger than a second thickness indicating a thickness of the second oxide films.

### Additional Embodiment 2

The magnetic base body of Additional Embodiment 1, wherein the first thickness is two or more times as large as the second thickness.

### Additional Embodiment 3

The magnetic base body of Additional Embodiment 1 or 2, wherein the first thickness is four or less times as large as the second thickness.

### Additional Embodiment 4

The magnetic base body of any one of Additional Embodiments 1 to 3, wherein a standard deviation of the thickness of the first oxide films is 3 nm or smaller.

### Additional Embodiment 5

The magnetic base body of any one of Additional Embodiments 1 to 4, wherein the element a is Cr.

### Additional Embodiment 6

The magnetic base body of any one of Additional Embodiments 1 to 5, wherein the element a is Al.

### Additional Embodiment 7

The magnetic base body of any one of Additional Embodiments 1 to 6, wherein the thickness of the first oxide films is from 10 nm to 50 nm.

### Additional Embodiment 8

A coil component comprising:
the magnetic base body of any one of Additional Embodiments 1 to 7; and
a coil conductor provided in the magnetic base body.

### Additional Embodiment 9

A circuit board comprising the coil component of Additional Embodiment 8.

### Additional Embodiment 10

An electronic component comprising the circuit board of Additional Embodiment 9.

What is claimed is:

1. A magnetic base body comprising:
a plurality of metal magnetic particles containing Fe, Si, and an element a;
first oxide films covering surfaces of the plurality of metal magnetic particles and composed mainly of an oxide of Si; and
second oxide films covering surfaces of the first oxide films and composed mainly of an oxide of the element a,
wherein a first thickness indicating a thickness of the first oxide films is larger than a second thickness indicating a thickness of the second oxide films.

2. The magnetic base body of claim 1, wherein the first thickness is two or more times as large as the second thickness.

3. The magnetic base body of claim 1, wherein the first thickness is four or less times as large as the second thickness.

4. The magnetic base body of claim 1, wherein a standard deviation of the thickness of the first oxide films is 3 nm or smaller.

5. The magnetic base body of claim 1, wherein the element a is Cr.

6. The magnetic base body of claim 1, wherein the element a is Al.

7. The magnetic base body of claim 1, wherein the thickness of the first oxide films is from 10 nm to 50 nm.

8. A coil component comprising:
the magnetic base body of claim 1; and
a coil conductor provided in the magnetic base body.

9. A circuit board comprising the coil component of claim 8.

10. An electronic component comprising the circuit board of claim 9.
